(19) United States
(12) Patent Application Publication
(10) Pub. No.: US 2016/0219625 A1
(43) Pub. Date: Jul. 28, 2016

(54) METHOD FOR DETECTING CAMP-ON AND CAMP-OFF OF MOBILE TERMINAL FOR ZONE BASED SERVICE IN MOBILE COMMUNICATION SYSTEM

(71) Applicant: Electronics and Telecommunications Research Institute, Daejeon (KR)

(72) Inventors: Seung Que LEE, Daejeon (KR); Dong Seung KWON, Daejeon (KR); Jin Up KIM, Daejeon (KR)

(73) Assignee: Electronics and Telecommunications Research Institute, Daejeon (KR)

(21) Appl. No.: 14/661,184

(22) Filed: Mar. 18, 2015

(30) Foreign Application Priority Data
Jan. 27, 2015 (KR) 10-2015-0012947

(51) Int. Cl. H04W 74/08; H04W 36/00

(52) U.S. Cl. CPC H04W 74/0833; H04W 36/0061

(57) ABSTRACT

Disclosed is a method for detecting cell camp-on and camp-off of a mobile terminal, in which a base station provides an effective zone based service by directly and simply detecting small cell camp-on and camp off of the mobile terminal without a help from a core network, that is, without a separate NAS message under a small cell environment of a mobile communication system by enhancing a tracking area update request processing scheme of the mobile terminal.

### CROSS-REFERENCE TO RELATED APPLICATIONS

This application claims priority to and the benefit of Korean Patent Application No. 10-2015-0012947 filed in the Korean Intellectual Property Office on Jan. 27, 2015, the entire contents of which are incorporated herein by reference.

### TECHNICAL FIELD

The present invention relates to a method for detecting cell camp-on and camp-off of a mobile terminal for a zone based service in a mobile communication system, and particularly, to a method for detecting cell camp-on and camp-off of a mobile terminal, in which a base station can provide an effective zone based service by detecting small cell camp-on and camp-off of a terminal under a small cell environment of a mobile communication system.

### BACKGROUND ART

A zone based service provides to a user who enters a specific region with various functions based on the region. Since a cell operating scheme of a mobile communication system tends to move from the center of a macro cell to the center of a small cell such as a micro cell, a pico cell, a femto cell, or the like, a function to provide a service based on Presence, Location, Context, and the like to a mobile communication subscriber who enters a small region is expected to be settled as a future mobile communication service.

Since the small cell has a small cell size unlike the macro cell, the small cell has a characteristic in that the cell is personalized. That is, users who camp on or camp off are unspecific many in a public region in the macro cell, while the users who cell-camp on or camp off may be an owner of the cell or a user who relates with the owner, such as a family member, an employee of a company, a customer of a store, and the like in the small cell. Accordingly, a cell camp-on or camp-off accident by the user in the small cell becomes very meaningful information to be used in the zone based service.

The zone based service may include, for example, a TO-DO service. This service is a service that, when a user preregisters a work to be done in a corresponding zone for each zone, notifies the work which the user is to do by detecting user's entering in the case where the user enters the zone. For example, in the case where the user registers a work to be done, such as task submission in a lecture room, the TO-DO service may give a task submission guidance to the user when the user's entering is detected. When the user registers shopping lists in a shopping mall, the TO-DO service notifies the lists to the user. The TO-DO service is available when the user deviates from the zone. In the case where rain falls at present or there is a high possibility that the rain will fall, the TO-DO service may send a message to bring an umbrella by detecting user's leaving home when the user leaves the home.

In order to provide the zone based service, a base station needs to detect the cell camp-on or camp-off accident by the user. In the existing standard technology, a terminal performs cell selection and reselection based on signal information of the base station and there is no procedure that explicitly notifies this event to the base station. This event may be notified to the base station and a core network during Attach, Service Request, Detach, and Handover of the terminal, but this event is not an event that is associated with all camp-on or camp-off terminals in that the event targets only a terminal requiring the function. For example, the base station and the core network may not detect the small cell camp-on or camp-off event of the terminal until the terminal makes an explicit tracking area update request when the cell is changed while the terminal is changed to an idle state due to disuse of data after the Attach.

Messages in the Attach, Service Request, Detach, and Handover as non access stratum (NAS) messages are transfer messages between the terminal and the core network. The base station provides only a connection passage and the base station is prohibited from intercepting the NAS message. Although the base station attempts to interrupt the NAS message for the zone based service, the base station cannot analyze the NAS message because the NAS message is encrypted by a security rule between the terminal and the core network. Therefore, it cannot be known which user camps on or camps off.

Meanwhile, when a tracking area identifier (TAI) and a tracking area identifier list (TAI list) are adjusted so as to make the tracking area update request per zone every time, camp-on/camp-off of a mobile terminal can be detected by the core network even under a current standard. However, as the number of tracking area update request messages increases, there is a disadvantage that a signal load between the base station and the core network is very high.

As described above, in a method in the related art, which detects the cell camp-on and camp-off event of the mobile terminal in a mobile communication system, only the core network that can analyze the NAS message can detect the cell camp-on/off targeting only a terminal that generates the NAS message. Further, with the increase in the number of NAS messages, there is a disadvantage in that the signal load between the base station and the core network explosively increases.

### SUMMARY OF THE INVENTION

The present invention has been made in an effort to provide a method for detecting small cell camp-on and camp-off of a mobile terminal, in which a base station can provide an effective zone based service by directly and simply detecting small cell camp-on and camp off of the mobile terminal without a help from a core network, that is, without a separate NAS message under a small cell environment of a mobile communication system by enhancing a tracking area update request processing scheme of the mobile terminal.

An exemplary embodiment of the present invention provides a method for providing a zone based service by detecting cell camp-on or camp-off of a mobile terminal in a small cell base station of a mobile communication system, including: transmitting, by the mobile terminal, a random access preamble message to the small cell base station; transmitting, by the small cell base station, a random access response message to the mobile terminal; and transmitting, by the mobile terminal, a scheduled transmission message including a service identifier for the zone based service and information on an event type for notifying the cell camp-on or camp-off in addition to a terminal identifier to the small cell base station.

The method may further include before the transmitting of the random access preamble message, transmitting a random access preamble assignment message to the mobile terminal from the base station.

The method for providing the zone based service may be achieved when the mobile terminal decides cell selection or cell reselection of entering a new cell from a previous cell or decides hand-over.

Another exemplary embodiment of the present invention provides a method for providing a zone based service by detecting cell camp-on or camp-off of a mobile terminal in a small cell base station of a mobile communication system, including: deciding, by the mobile terminal, attach or a tracking area update request subsequently after deciding cell selection or cell reselection of entering a new cell from a previous cell; transmitting, by the mobile terminal, a random access preamble message to a base station of the previous cell; transmitting, by the base station of the previous cell, a random access response message to the mobile terminal; and transmitting, by the mobile terminal, a scheduled transmission message including a service identifier for the zone based service and information on an event type for notifying the cell camp-off in addition to a terminal identifier to the base station of the previous cell.

The method may further include: transmitting, by the mobile terminal, the random access preamble message to a base station of the new cell; transmitting, by the base station of the new cell, a random access response message to the mobile terminal; and transmitting, by the mobile terminal, a scheduled transmission message including information for a service identifier for the zone based service in addition to a terminal identifier to the base station of the new cell. The scheduled transmission message transmitted to the base station of the new cell from the mobile terminal may further include information on an event type for notifying the cell camp-on.

Yet another exemplary embodiment of the present invention provides a method for providing a zone based service by detecting cell camp-on or camp-off of a mobile terminal in a small cell base station of a mobile communication system, including: deciding, by the mobile terminal, cell selection or cell reselection of entering a new cell from a previous cell; transmitting, by the mobile terminal, a random access preamble message to a base station of the previous cell; transmitting, by the base station of the previous cell, a random access response message to the mobile terminal; and transmitting, by the mobile terminal, a scheduled transmission message including a service identifier for the zone based service and information on an event type for notifying the cell camp-off in addition to a terminal identifier to the base station of the previous cell.

The method may further include: transmitting, by the mobile terminal, the random access preamble message to a base station of the new cell; transmitting, by the base station of the new cell, a random access response message to the mobile terminal; and transmitting, by the mobile terminal, a scheduled transmission message including information for a service identifier for the zone based service in addition to a terminal identifier to the base station of the new cell. The scheduled transmission message transmitted to the base station of the new cell from the mobile terminal may further include information on an event type for notifying the cell camp-on.

Still another exemplary embodiment of the present invention provides a method for providing a zone based service by detecting cell camp-on or camp-off of a mobile terminal in a small cell base station of a mobile communication system, including: deciding, by the mobile terminal, hand-over of entering a new target cell from a previous source cell; transmitting, by the mobile terminal, a random access preamble message to a base station of the previous source cell; transmitting, by the base station of the previous source cell, a random access response message to the mobile terminal; and transmitting, by the mobile terminal, a scheduled transmission message including a service identifier for the zone based service and information on an event type for notifying the cell camp-off in addition to a terminal identifier to the base station of the previous source cell.

The method may further include: transmitting, by a base station of the new target cell, a random access preamble assignment message to the mobile terminal; transmitting, by the mobile terminal, the random access preamble message to a base station of the new target cell; transmitting, by the base station of the new target cell, the random access response message to the mobile terminal; and transmitting, by the mobile terminal, a scheduled transmission message including information for a service identifier for the zone based service in addition to a terminal identifier to the base station of the new target cell. The scheduled transmission message transmitted to the base station of the new target cell from the mobile terminal may further include information on an event type for notifying the cell camp-on.

According to exemplary embodiments of the present invention, in a method for detecting cell camp-on and camp-off of a mobile terminal for a zone based service in a mobile communication system, a base station can effectively provide the zone based service by directly and simply detecting small cell camp-on and camp off of the mobile terminal without a help from a core network, that is, without a separate NAS message under a small cell environment of the mobile communication system.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a flowchart for describing an operating principle of detecting cell camp-on and camp-off of a mobile terminal in a base station in a mobile communication system according to an exemplary embodiment of the present invention.

FIG. 2 illustrates an application example when Attach or a tracking area update request is required subsequently during cell selection or reselection in which a terminal enters a new cell from a previous cell in the operating principle of detecting the cell camp-on and camp-off of FIG. 1.

FIG. 3 illustrates an application example of a case in which the terminal is handover by entering the new cell from the previous cell in the operating principle of detecting the cell camp-on and camp-off of FIG. 1.

FIG. 4 illustrates an application example of notifying the cell camp-off to the previous cell when the Attach or tracking area update request is not required subsequently during a change of the cell such as the cell selection, reselection, or handover in which the terminal enters the new cell from the previous cell in the operating principle of detecting the cell camp-on and camp-off of FIG. 1.

FIG. 5 illustrates an example of a case of notifying the cell camp-on/off by applying the procedures of FIGS. 2 and 4 according to the Attach or tracking area update request being required subsequently during the cell selection or reselection in which the terminal enters the new cell from the previous cell according to the exemplary embodiment of the present invention.

FIG. 6 illustrates an example of a case of notifying the cell camp-on/off by applying the procedures of FIGS. 3 and 4 when the terminal is handed over by entering the new cell from the previous cell according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. Further, a detailed description of an already known function and/or configuration will be skipped. In contents disclosed hereinbelow, a part required for understanding an operation according to various exemplary embodiments will be described in priority and a description of elements which may obscure the spirit of the present invention will be skipped. Further, some components of the drawings may be enlarged, omitted, or schematically illustrated. An actual size is not fully reflected on the size of each component and therefore, contents disclosed herein are not limited by relative sizes or intervals of the components drawn in the respective drawings.

As long as not particularly mentioned in the present invention, a base station means base stations such as (BS) means a femto cell base station, a pico cell base station, a micro cell base station, and the like and for example, the femto cell base station may include a Home NodeB (HNB) in a 3rd Generation Partnership Project) UMTS (Universal Mobile Telecommunications System (3GPP) and a Home eNodeB (HeNB) in a 3GPP long term evolution (LTE). Further, in the present invention, a terminal (mobile station (MS)) may include a smart phone, a tablet PC, a notebook PC, a desktop PC, and other electronic devices which may communicate with mobile communications (e.g., WCDMA, LTE, and the like), the Internet (e.g., WiBro and WiFi), and a server of a core network which interlocks with other wireless/wired networks through the base station.

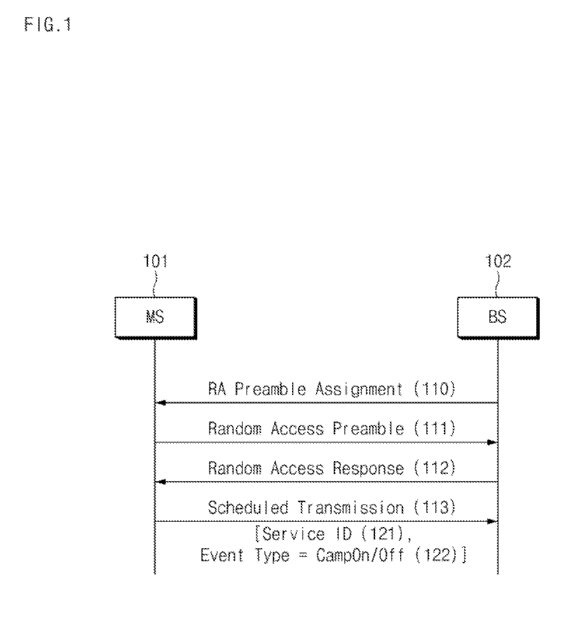

FIG. 1 is a flowchart for describing an operating principle of detecting cell camp-on and camp-off of a mobile terminal in a base station in a mobile communication system according to an exemplary embodiment of the present invention.

In the present invention, a random access procedure in the related art is modified. In the random access procedure based on contention between an MS 101 which is a mobile terminal and a BS 102 which is a small cell base station, first, the MS 101 sends a random access preamble message 111 loaded with a random access channel (RACH) preamble for synchronization to the BS 102 and thereafter, the BS 102 examines a collision with other terminals and when there is no collision, the BS 102 responds to a request by the MS 101 with a random access response message 112 including identifier information, timing information, resource assignment information, and the like.

In a non-contention based random access procedure such as handover, or the like, before the random access preamble message 111, the BS 102 assigns a preamble without an inter-terminal collision to send down a random access preamble assignment message 110 including information assigned with the preamble without the inter-terminal collision to the MS 101. In this case, transmission of the random access response message 112 is performed without the examination of the collision with other terminals.

Thereafter, the MS 101 which subscribes in the zone based service performs an access request by transmitting a scheduled transmission message 113 without the collision through a resource assigned by the BS 102 and in the present invention, a service ID 121 and an event type 122 are added to a scheduled transmission message 113 in addition to the existing parameters such as a terminal identifier, and the like.

The service ID 121 as a unique identifier or number for users who receive the zone based service is granted and managed by a service domain or a server of a service provider. The event type 122 as a type of an event which the MS 101 intends to notify to the BS 102 for the zone based service may cell camp-on, cell camp-off, and the like and when the service is extended afterwards, the event type may be further extended to various types which answer for a service purpose other than two types. As described below, during the cell camp-on, as the event type 122, the cell camp-on may be detected even by adding only the service ID 121 without adding cell camp-on information.

Without a separate control for the service by the server of the core network, the scheduled transmission message 113 added with the service ID 121 and the event type 122 is transmitted and received in the random access procedure, and as a result, the zone based service may be effectively supported without increasing a traffic load with the core network. When the MS 101 cell-camps on, a session is formed between the MS 101 and the BS 102 by the service ID 121 and the event type 122, and as a result, the BS 102 may relay data required for the zone based service to be transmitted and received between the MS 101 and the server of the core network. Further, when the MS 101 cell-camps off, the BS 102 detects the cell camp-off by the service ID 121 and the event type 122, and as a result, the session formed between the MS 101 and the BS 102 is cancelled. Even in the cell camp-off, when a user leaves home, the zone based service between the MS 101 and the server of the core network such as a service that notifies bringing an umbrella, or the like may be maintained by a control by the server of the core network as described in the above example.

As described even above, the zone based service may include a TO-DO service in which when the user preregisters in the MS 101 tasks (e.g., task submission at a lecture room, shopping lists in a shopping mall, notification of packing the umbrella when the user leaves home) to be done in a corresponding zone for each zone of coverage of the BS 102, in the case where the user enters the zone, the BS 102 detects the user's entrance to transmit and receive data required for the zone based service between the MS 101 and the server of the core network.

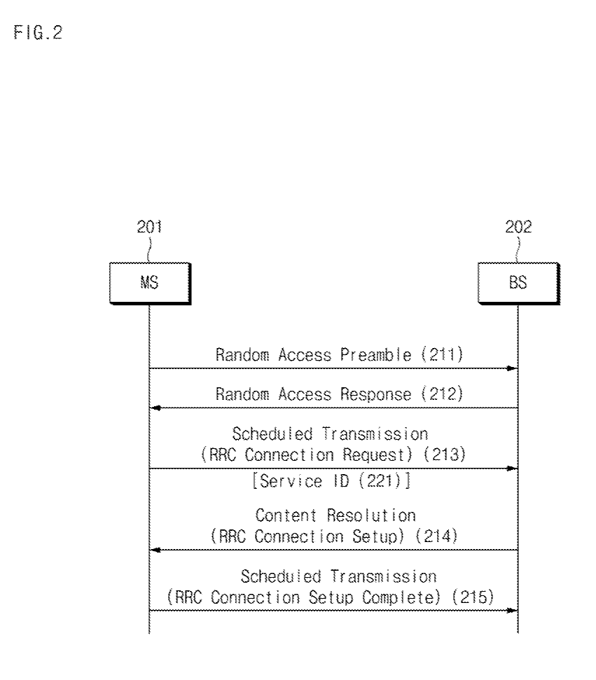

FIG. 2 illustrates an application example when Attach or a tracking area update request is required subsequently during cell selection or reselection in which a terminal enters a new cell from a previous cell in the operating principle of detecting the cell camp-on and camp-off of FIG. 1.

For example, a terminal MS 201 performs a procedure using non access stratum (NAS) messages 211 to 215 given below as an attach or tracking area update request process subsequently as necessary, such as a case for communication maintenance or service maintenance in cell selection or reselection in which the terminal MS 201 enters coverage of a BS 202 which is a new small cell base station from a previous small cell and adds a service ID 221 in step S213.

In the attach or tracking area update request process which is a random access procedure based on contention between the MS 201 and the BS 202, first, the MS 201 sends a random access preamble message 211 loaded with a random access channel (RACH) preamble for synchronization to the BS 202 and thereafter, the BS 202 examines a collision with other terminals and when there is no collision, the BS 202 responds to a request by the MS 201 with a random access response message 212 including identifier information, timing information, resource assignment information, and the like.

Thereafter, the MS 201 which subscribes in the zone based service performs an access request by transmitting an RRC connection request message 213 which is the scheduled transmission message without the collision through a resource assigned by the BS 202 and in this case, in the present invention, a service ID 221 is added to the scheduled transmission message 213 in addition to the existing parameters such as the terminal identifier, and the like. In this case, cell camp-on information may be further added as the event type.

Thereafter, the BS 202 transmits a radio resource control connection setup message 214 which is a contention resolution message and the MS 201 that receives the transmitted message correspondingly transmits an RRC connection setup request message 215 which is a scheduled transmission message for notifying completion after internal setup to the BS 202.

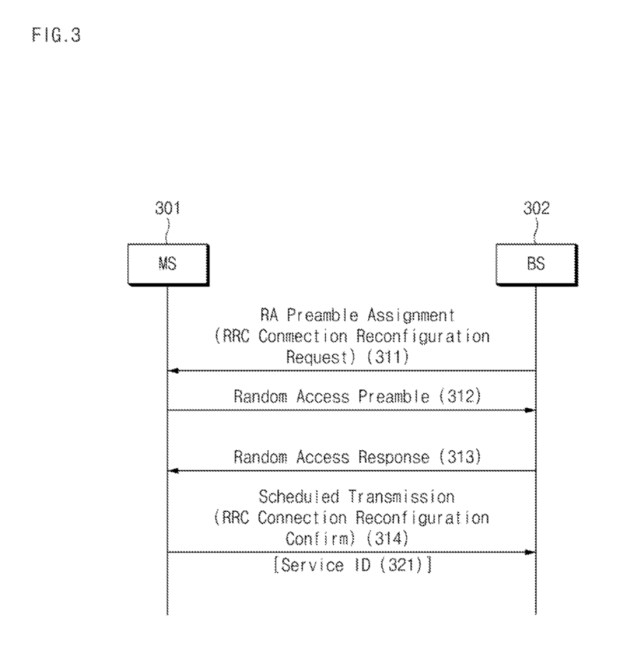

FIG. 3 illustrates an application example of a case in which the terminal is handover by entering the new cell from the previous cell in the operating principle of detecting the cell camp-on and camp-off of FIG. 1.

For example, when a terminal MS 301 decides hand-over by entering coverage of a BS 302 which is a new small cell base station from a previous small cell, the terminal MS 301 performs a procedure using non access stratum messages 311 to 314 given below and adds a service ID 321 in step S314.

That is, in a random access procedure for the hand-over between the MS 301 and the BS 302, first, the BS 302 may send down to the MS 301 an RRC connection reconfiguration request message 311 which is a random access preamble assignment message including information assigned with the preamble without the inter-terminal collision.

Thereafter, similarly in FIG. 1, the MS 301 sends a random access preamble message 312 loaded with the random access channel (RACH) preamble for synchronization to the BS 302 and thereafter, the BS 302 does not examine a collision with other terminals and responds to a request by the MS 301 with a random access response message 313 including the identifier information, the timing information, the resource allocation information, and the like.

Thereafter, the MS 301 which subscribes in the zone based service performs an access request by transmitting an RRC connection reconfiguration message 314 which is the scheduled transmission message without the collision through a resource assigned by the BS 302 and in this case, in the present invention, a service ID 321 is added to a scheduled transmission message 314 in addition to the existing parameters such as the terminal identifier, and the like. In this case, the cell camp-on information may be further added as the event type.

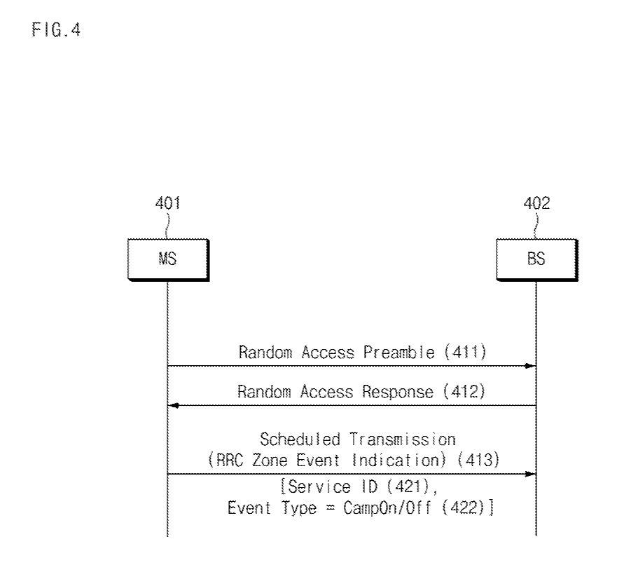

FIG. 4 illustrates an application example of notifying the cell camp-off to the previous cell when the Attach or tracking area update request is not required subsequently during a change of the cell such as the cell selection, reselection, or handover in which the terminal enters the new cell from the previous cell in the operating principle of detecting the cell camp-on and camp-off of FIG. 1.

For example, a terminal MS 401 performs a procedure using non access stratum (NAS) messages 411 to 413 given below, which are used for notifying the cell camp-off to the previous cell for the zone based service when the attach or tracking area update request process is not required subsequently during a change of the cell, cell selection, reselection, or hand-over in which the MS 401 enters coverage of a BS 402 which is a new small cell base station from a previous small cell and adds a service ID 421 and an event type 422 in step S413.

That is, as a random access procedure based on contention between the MS 401 and the BS 402, first, the MS 401 sends a random access preamble message 411 loaded with the random access channel (RACH) preamble for synchronization to the BS 402 and thereafter, the BS 402 examines a collision with other terminals and when there is no collision, the BS 401 responds to a request by the MS 401 with a random access response message 412 including the identifier information, the timing information, the resource allocation information, and the like.

Thereafter, the MS 401 that subscribes in the zone based service transmits a newly defined RRC zone event indication 413 as the scheduled transmission message without the collision through the resource assigned by the BS 402 to perform the access request and in this case, the scheduled transmission message 113 includes a terminal identifier, the service ID 421, and the event type 422.

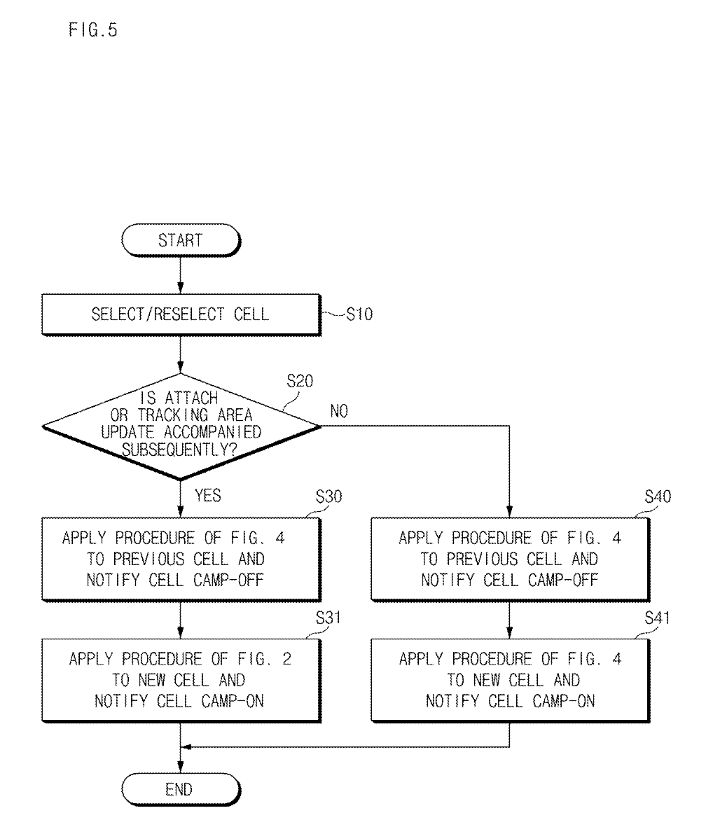

FIG. 5 illustrates an example of a case of notifying the cell camp-on/off by applying the procedures of FIGS. 2 and 4 according to the Attach or tracking area update request being required subsequently during the cell selection or reselection in which the terminal enters the new cell from the previous cell according to the exemplary embodiment of the present invention.

For example, when an MS that subscribes in a zone based service decides cell selection or reselection in which the MS enters coverage of a new small cell BS from a previous small cell (S10), it is examined whether an attach or tracking area update request process is required subsequently for communication maintenance or service maintenance (S20).

In this case, when the attach or tracking area update request process is required (S20), the cell camp-off is notified to a previous cell base station by adding the service ID 421 and the event type 422 (e.g., cell camp-off information) in addition to the terminal identifier to the scheduled transmission message 113 by using the procedures including reference numerals 411 to 413 of FIG. 4 (S30) and thereafter, the cell camp-on is notified by adding the service ID 221 in addition to the existing parameters such as the terminal identifier, and the like to the RRC connection request message 213 which is the scheduled transmission message to a new cell base station by using the procedure including reference numerals 211 to 215 of FIG. 2 (S31). In this case, the cell camp-on information may be added as the event type.

On the contrary, when the attach or tracking area update request process is not required (S20), the cell camp-off is notified to the previous cell base station by adding the service ID 421 and the event type 422 (e.g., cell camp-off information) in addition to the terminal identifier to the scheduled transmission message 113 by using the procedures including reference numerals 411 to 413 of FIG. 4 again (S40) and thereafter, the cell camp-on is notified by adding the service ID 421 and the event type 422 (e.g., cell camp-on information) in addition to the terminal identifier to the scheduled transmission message to the new cell base station by using the procedure including reference numerals 411 to 413 of FIG. 4 again (S41). In this case, the event type information is not added and the cell camp-on may be detected by only the service ID 421.

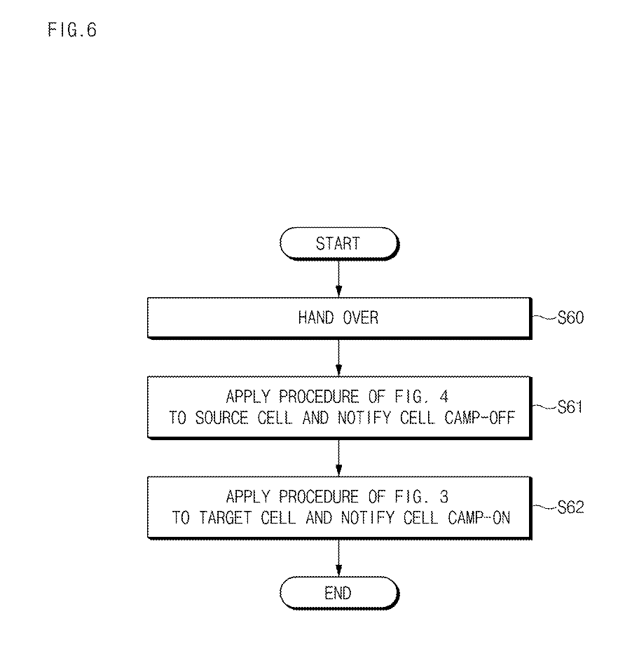

FIG. 6 illustrates an example of a case of notifying the cell camp-on/off by applying the procedures of FIGS. 3 and 4 when the terminal is handed over by entering the new cell from the previous cell according to the exemplary embodiment of the present invention.

For example, when the terminal MS enters the coverage of the BS which is the new small cell base station from the previous small cell to decide the hand-over (S60), the cell camp-off is notified to the previous source cell base station by adding the service ID 421 and the event type 422 (e.g., cell camp-off information) in addition to the terminal identifier to the scheduled transmission message 113 by using the procedure including reference numerals 411 to 413 of FIG. 4 (S61) and thereafter, the cell camp-on is notified by adding the service ID 321 in addition to the existing parameters such as the terminal identifier, and the like to the RRC connection reconfiguration message 314 which is the scheduled transmission message to a new target cell base station by using the procedure including reference numerals 311 to 314 of FIG. 3 (S62). In this case, the cell camp-on information may be added as the event type.

As described above, in the mobile communication system according to the exemplary embodiment of the present invention, small cell base stations such as a femto cell base station, a pico cell base station, a micro cell base station, and the like can provide an effective zone based service by directly and simply detecting small cell camp-on and camp off of the mobile terminal without a help from a core network, that is, without a separate NAS message.

The present invention has been described by the specified matters and limited embodiments and drawings such as specific components in the present invention, which are provided to help overall understanding of the present invention and is not limited thereto, and those skilled in the art will appreciate that various modifications and changes can be made within the scope without departing from an essential characteristic of the present invention. The spirit of the present invention is defined only the exemplary embodiments described above and it should be appreciated that all technical spirits which are equivalent to the appended claims in addition to the appended claims to be described beloware included in the claims of the present invention.

What is claimed is:

1. A method for providing a zone based service by detecting cell camp-on or camp-off of a mobile terminal in a small cell base station of a mobile communication system, the method comprising:
transmitting, by the mobile terminal, a random access preamble message to the small cell base station;
transmitting, by the small cell base station, a random access response message to the mobile terminal; and
transmitting, by the mobile terminal, a scheduled transmission message including a service identifier for the zone based service and information on an event type for notifying the cell camp-on or camp-off in addition to a terminal identifier to the small cell base station.

2. The method of claim 1, further comprising:
before the transmitting of the random access preamble message,
transmitting a random access preamble assignment message to the mobile terminal from the base station.

3. The method of claim 1, wherein the method for providing the zone based service is achieved when the mobile terminal decides cell selection or cell reselection of entering a new cell from a previous cell or decides hand-over.

4. A method for providing a zone based service by detecting cell camp-on or camp-off of a mobile terminal in a small cell base station of a mobile communication system, the method comprising:
deciding, by the mobile terminal, attach or a tracking area update request subsequently after deciding cell selection or cell reselection of entering a new cell from a previous cell;
transmitting, by the mobile terminal, a random access preamble message to a base station of the previous cell;
transmitting, by the base station of the previous cell, a random access response message to the mobile terminal; and
transmitting, by the mobile terminal, a scheduled transmission message including a service identifier for the zone based service and information on an event type for notifying the cell camp-off in addition to a terminal identifier to the base station of the previous cell.

5. The method of claim 4, further comprising:
transmitting, by the mobile terminal, the random access preamble message to a base station of the new cell;
transmitting, by the base station of the new cell, a random access response message to the mobile terminal; and
transmitting, by the mobile terminal, a scheduled transmission message including information for a service identifier for the zone based service in addition to a terminal identifier to the base station of the new cell.

6. The method of claim 5, wherein the scheduled transmission message transmitted to the base station of the new cell from the mobile terminal further includes information on an event type for notifying the cell camp-on.

7. A method for providing a zone based service by detecting cell camp-on or camp-off of a mobile terminal in a small cell base station of a mobile communication system, the method comprising:
deciding, by the mobile terminal, cell selection or cell reselection of entering a new cell from a previous cell;
transmitting, by the mobile terminal, a random access preamble message to a base station of the previous cell;
transmitting, by the base station of the previous cell, a random access response message to the mobile terminal; and
transmitting, by the mobile terminal, a scheduled transmission message including a service identifier for the zone based service and information on an event type for notifying the cell camp-off in addition to a terminal identifier to the base station of the previous cell.

8. The method of claim 7, further comprising:
transmitting, by the mobile terminal, the random access preamble message to a base station of the new cell;
transmitting, by the base station of the new cell, a random access response message to the mobile terminal; and
transmitting, by the mobile terminal, a scheduled transmission message including information for a service identifier for the zone based service in addition to a terminal identifier to the base station of the new cell.

9. The method of claim 8, wherein the scheduled transmission message transmitted to the base station of the new cell from the mobile terminal further includes information on an event type for notifying the cell camp-on.

10. A method for providing a zone based service by detecting cell camp-on or camp-off of a mobile terminal in a small cell base station of a mobile communication system, the method comprising:
deciding, by the mobile terminal, hand-over of entering a new target cell from a previous source cell;
transmitting, by the mobile terminal, a random access preamble message to a base station of the previous source cell;
transmitting, by the base station of the previous source cell, a random access response message to the mobile terminal; and
transmitting, by the mobile terminal, a scheduled transmission message including a service identifier for the zone based service and information on an event type for notifying the cell camp-off in addition to a terminal identifier to the base station of the previous source cell.

11. The method of claim 10, further comprising:
transmitting, by a base station of the new target cell, a random access preamble assignment message to the mobile terminal;
transmitting, by the mobile terminal, the random access preamble message to a base station of the new target cell;
transmitting, by the base station of the new target cell, the random access response message to the mobile terminal; and
transmitting, by the mobile terminal, a scheduled transmission message including information for a service identifier for the zone based service in addition to a terminal identifier to the base station of the new target cell.

12. The method of claim 11, wherein the scheduled transmission message transmitted to the base station of the new target cell from the mobile terminal further includes information on an event type for notifying the cell camp-on.
